(19) United States
(12) Patent Application Publication
(10) Pub. No.: US 2002/0032607 A1
(43) Pub. Date: Mar. 14, 2002

(54) Point management apparatus, commodity and service providing apparatus, settlement mediating apparatus, and network point-settling system

(76) Inventor: Toru Kuwahara, Kanagawa (JP)

Correspondence Address: ROSENMAN & COLIN LLP, 575 MADISON AVENUE, NEW YORK, NY, 10022-2585, US

(21) Appl. No.: 09/876,885

(22) Filed: Jun. 7, 2001

(30) Foreign Application Priority Data
Jun. 8, 2000 (JP) 2000-172043
Jun. 4, 2001 (JP) 2001-168486

(51) Int. Cl. G06F 17/60

(52) U.S. Cl. 705/14

(57) ABSTRACT

A customer terminal (1) obtains points from online shop set up by a store server (2). The customer terminal (1) requests the store server (2) that the points be used for payment to a business entity server (3). Having received this request, the store server (2) calls a Web page of the business entity server (3). The business entity server (3) receives the point use request by the customer terminal (1), and charges an amount of money corresponding to the allotted points to the store server (2). Thus, the present invention realizes a new form of point service in which points given as customer service can be also used in another store.

This application claims a priority based on Japanese Patent Application Nos. 2000-172043 and 2001-16848 filed on Jun. 8, 2000, and Jun. 4, 2001 respectively, the entire contents of which are incorporated herein by reference for all purposes.

### BACKGROUND OF THE INVENTION

1. Field of the Invention

The present invention relates to points (to be) given to a customer who has purchased a commodity, and. particularly, to a technique for realizing a system in which points obtained in one virtual store utilizing a computer network can be used in another store.

2. Related Art Statement

With the intention of exciting customers' will to purchase or enclosing customers, many actual stores employ point service in which points are given to customers according to amounts of their purchases. In the point system, for example, points obtained by a customer have a monetary value in a store that has given those points. When a customer who has received points purchases a commodity in that store, he or she can allot those points for part of payment for its purchase price.

A customer will make a purchase in a store that provides point service and will also make a purchase again and again in the same store to use obtained points. The point service is therefore one of very effective sales strategies.

The above point service is increasingly employed not only in actual stores but also in virtual stores, i.e., so-called online shops, which constitute one of important sales types as Internet grows.

### SUMMARY OF THE INVENTION

It is generally seen that points given to a customer by an online shop in a certain Web site are valid only in that site. The reason is that one of objects of point service is to induce a customer to make a purchase again and again, and that, in addition, the points themselves have no monetary value for the other stores.

From the viewpoint of service to customers, however, it is attractive to customers to give points usable in other stores (sites). As a result, a good impression of the store is enhanced, and customers' will to purchase is excited. Thus, such service is considered effective as a new type of point service, from the viewpoint of sales strategies.

On the other hand, in order for a store to accept that points issued by another store are allotted, for example, to a purchase price of a commodity etc. of its own store, there is required a mechanism for compensating the store for an amount of money corresponding to those points, or counter balancing benefit is required.

The present invention has been made in view of such situations, and an object of the present invention is to provide a technique for realizing a new type of points service in which points given as customer service can be used in another store.

For achieving the above object, the present invention provides a point management apparatus for storing points that represent economic service to be provided to a customer according to a number of the points, with relating the points to the customer, comprising: a connection request receiving means for receiving a request for connection with a commodity/service providing apparatus through which the customer should pay money as a price of a commodity or enjoyment of service; a bearing amount transmitting means for transmitting information on an amount to be borne on the basis of the points related to said customer, to said commodity/service providing apparatus; and a payment request receiving means for receiving a payment request based on said amount to be borne, from said commodity/service providing apparatus.

Further, the present invention provides a commodity/service providing apparatus that provides a commodity or service to a customer on condition of payment of a price, comprising: a borne-amount receiving means for receiving information on an amount to be borne from a bearing guarantee apparatus that guarantees bearing for part or all of amount of money to be paid by said customer; a price demanding means for demanding payment of an amount of money obtained by subtracting said amount to be borne from the price of said commodity or service, from said customer; and a bearing amount demanding means for demanding payment of money based on said amount borne, from said bearing guarantee apparatus.

Further, the present invention provides a settlement mediating apparatus, comprising: a borne-amount receiving means for receiving information on an amount to be borne from a bearing guarantee apparatus that guarantees bearing for part or all of amount of money to be paid by a customer; a connection request receiving means for receiving a request for connection with a commodity/service providing apparatus through which the customer should pay money as a price of a commodity or enjoyment of service; borne-amount transmitting means for transmitting information on said amount to be borne, to said commodity/service providing apparatus; a payment request receiving means for receiving a request for payment of money based on said amount to be borne, from said commodity/service providing apparatus; and a borne-amount demanding means for demanding said payment of the money based on said amount to be borne, from said bearing guarantee apparatus.

Further, the present invention provides a network point settling system comprising the above-described apparatuses.

### BRIEF DESCRIPTION OF THE DRAWINGS

FIG. 1 is a block diagram for explaining an outline of a network point settling system of a first embodiment according to the present invention;

FIG. 2 is a diagram explaining flows of processing in the network point settling system;

FIG. 3 is a view explaining an example of an authentication screen of an online shop;

FIG. 4 is a view explaining an example of a commodity specifying screen;

FIG. 5 is a view explaining an example of a purchase procedure screen;

FIG. 6 is a view explaining an example of a point use screen;

FIG. 7 is a view explaining an example of an authentication/use acceptance screen;

FIG. 8 is a diagram showing data structure of a customer database 31 managed by a business entity server 3;

FIG. 9 is a view explaining an example of a point processing completion screen;

FIG. 10 is a block diagram for explaining an outline of a network point settling system of a second embodiment according to the present invention:

FIG. 11 is a diagram explaining flows of processing in the network point settling system of the second embodiment according to the present invention;

FIG. 12 is a view explaining an example of a point gate use screen;

FIG. 13 is a view explaining an example of a point use site selection screen;

FIG. 14 is a view explaining an example of a purchasing ticket specifying screen;

FIG. 15 is a view explaining an example of a purchase procedure screen; and

FIG. 16 is a block diagram for explaining an outline of a network point settling system in which a point gate connects a plurality of stores and a plurality of business entities.

### DETAILED DESCRIPTION

Embodiments of the present invention will be described in detail with reference to drawings. To begin with, a first embodiment of the present invention will be described.

In the present embodiment, a store runs an online shop on a computer network. For exciting customer's incentive to purchase, the store employs point service in which the store gives points corresponding to a purchase amount to a customer when it receives an order from the customer. Those points can be used in the site of the online shop at the conversion rate of, for example, 1 yen to one point for receiving discount service corresponding to points used in the next purchasing, or for exchanging a prescribed number of points for a premium commodity. Further, a customer can use the obtained points not only for purchasing a commodity in the site but also for paying another business entity different from the store.

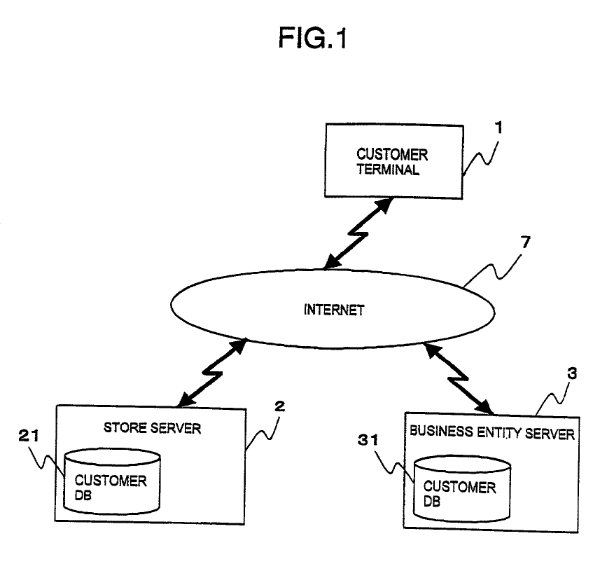

FIG. 1 is a block diagram for explaining an outline of a network point settling system as the first embodiment according to the present invention. As shown in the figure, the network point settling system of the first embodiment comprises a customer terminal 1, a store server 2, and a business entity server 3, which are connected with one another through Internet 7.

A user of the customer terminal 1 has already finished registration as a customer of the store server 2, and can use the online shop set up by the store server 2. Namely, a customer database 21 managed by the store server 2 has registered a customer ID and password for specifying the user of the customer terminal 1, an E-mail address, a commodity delivery address, credit card information required for settling, a purchase history, and the like.

The customer terminal 1 is placed in an environment where Internet 7 can be used, and may be implemented by a personal computer or the like having a function of a WWW browser.

The store server 2 sets up the online shop on Internet 7. This online shop offers point service, and gives points corresponding, for example, to a purchase amount to a customer who purchases a commodity, service, or the like.

The store server 2 records the points given to the customer into the customer database 21, with relating the points to the customer ID.

Points accumulated by the customer can be allotted to part of a purchase price In purchasing a commodity in the online shop, for example, at the conversion rate of 1 yen to 1 point.

The store server 2 is placed in an environment where Internet 7 can be used, and may be implemented by a server computer or the like having a function of a WWW server. A server computer or the like can start functioning as the store server 2 when it executes processing according to a prescribed computer program. The computer program for making a server computer or the like function as the store server 2 can be distributed, for example, by recording it on a portable storage medium such as a CD-ROM. The same can be said of each server to be described below.

A business entity that operates the business entity server 3 is a different organization from the store that operates the store server 2, and offers customer service involving payment of a price on Internet 7. This customer service may take a form, for example, of an online shop different from the store server 2 or may be communication service as an Internet provider or the like.

To receive the customer service offered by the business entity that operates the business entity server 3, registration as a customer of the business entity server 3 is required in advances. The user of the customer terminal 1 has finished registration as a customer of the business entity server 3, and can use the customer service offered by the business entity that operates the business entity server 3. Namely, a customer database 31 managed by the business entity server 3 has registered a customer ID and password for specifying the user of the customer terminal 1, an E-mail address, credit card information required for settling, and the like. The above customer ID and password registered in the business entity server 3 are not necessarily required to be the same as the customer ID and password registered in the store server 2.

In the present embodiment, the user of the customer terminal 1 can use points given by the store server 2, for payment for service received (to be received) from the business entity that operates the business entity server 3.

Processing in the first embodiment will be specifically described below. In this embodiment, it is assumed that the business entity that operates the business entity server 3 is an Internet provider, and that the customer terminal I uses connection service of the business entity that operates the business entity server 3, to connect with Internet 7. Further, it is assumed that, as a price of this connection service, the user of the customer terminal 1 pays a fixed-amount connection charge per month to the business entity that operates the business entity server 3.

The business entity that operates the business entity server 3 and the store that operates the store server 2 are different organizations from each other, each setting up a different Web site on Internet 7. However, they make a contract to the effect that points given to a customer by the store server 2 can be used for customer's payment to the business entity that operates the business entity server 3, and a contract to the effect that the store that operates the store server 2 pays an amount of money corresponding to used points to the business entity that operates the business entity server 3.

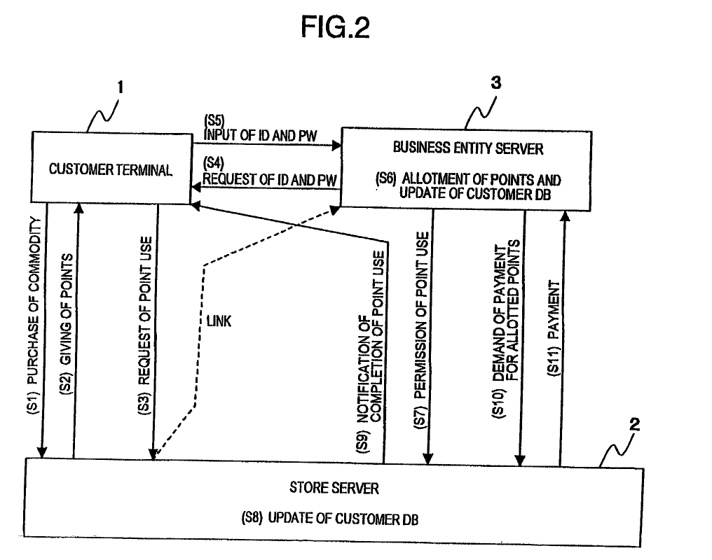

FIG. 2 is a diagram explaining flows of processing in the network point settling system under such conditions.

First, the user of the customer terminal 1 purchases a desired commodity at the online shop set up by the store server 2 (S1).

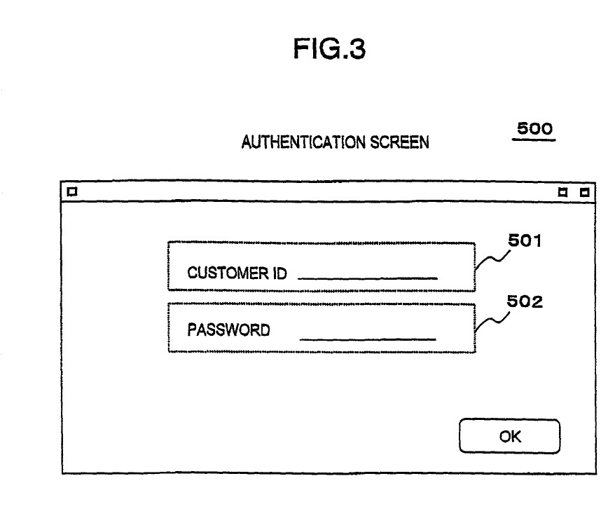

Specifically, when the user of the customer terminal 1 makes a request to the store server 2 for use of the online shop, the store server 2 displays an online shop's authentication screen 500, for example as shown in FIG. 3, on the customer terminal 1. The user of the customer terminal 1 inputs the customer ID and password, which have been registered in advance, into a customer ID input field 501 and a password input field 502, respectively, to undergo authentication processing.

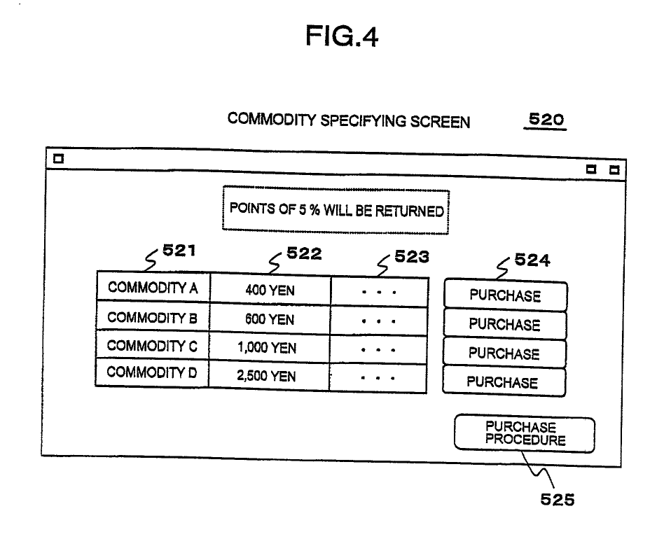

When the authentication processing identifies the user of the customer terminal 1, the store server 2 displays a commodity specifying screen 520, for example as shown in FIG. 4, on the customer terminal 1, to receive specification of a commodity.

In the commodity specifying screen 520, the user of the customer terminal 1 can click purchase button(s) 524 for commodity(ies) 521 that he desires to purchase. After the specification of commodity(ies) ends, a purchase procedure button 525 can be clicked.

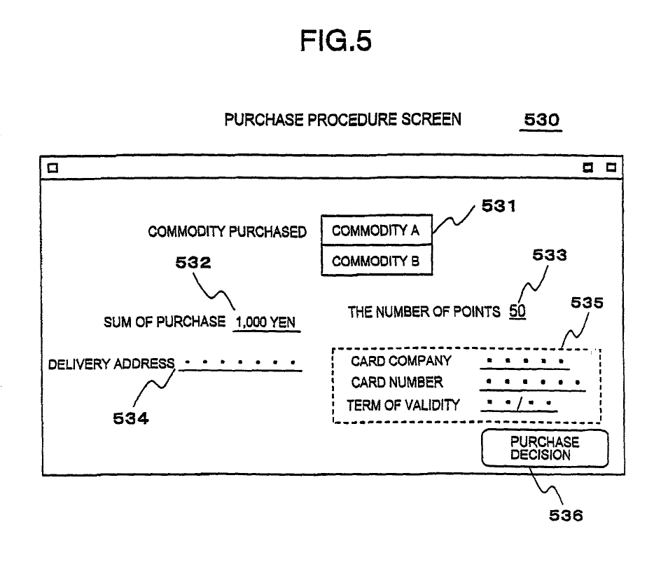

Upon receipt of the click of the purchase procedure button 525, the store server 2 displays a purchase procedure screen, for example as shown in FIG. 5, on the customer terminal 1. The purchase procedure screen 530 displays the commodity(ies) 531 whose specification has been received on the commodity specifying screen and information 532 on the selling prices thereof. Further, it also displays the pre-registered delivery address 534 and information 535 on settlement such as the credit card number, etc.

Further, the store server 2 has determined a point return rate, for example, as 5%, in advance, and displays the number of given points 533 obtained by multiplying the total amount of selling prices by the point return rate.

On the above purchase procedure screen 530, the user of the customer terminal 1 can decide the purchase by clicking the purchase decision button 536. Upon receipt of the click of the purchase decision button 536, the store server 2 presents a purchase confirmation screen to the user 1, and at the same time, makes a request to a settlement agency (not shown) for settlement processing and performs a commodity delivery procedure, management of the purchase history, etc.

Further, the number of points to give is added to the number of points that the user of the customer terminal 1 has already obtained, to record the result into the customer database 21, with relating it to the customer ID.

As a result of the above-described processing, the user of the customer terminal 1 can obtain the points (S2).

The points obtained by the user of the customer terminal 1 can be allotted to part of a purchase price in commodity purchase that takes place again or thereafter in the online shop set up by the store server 2, at a conversion rate, for example, of 1 yen to 1 point.

Further, in the present embodiment, these points can be allotted to a payment to the business entity that operates the business entity server 3. Specifically, the user of the customer terminal 1 can use the points for paying the connection charge to be paid to the provider, i.e., the business entity that operates the business entity server 3.

Processing in this case will be described again with reference to FIG. 2.

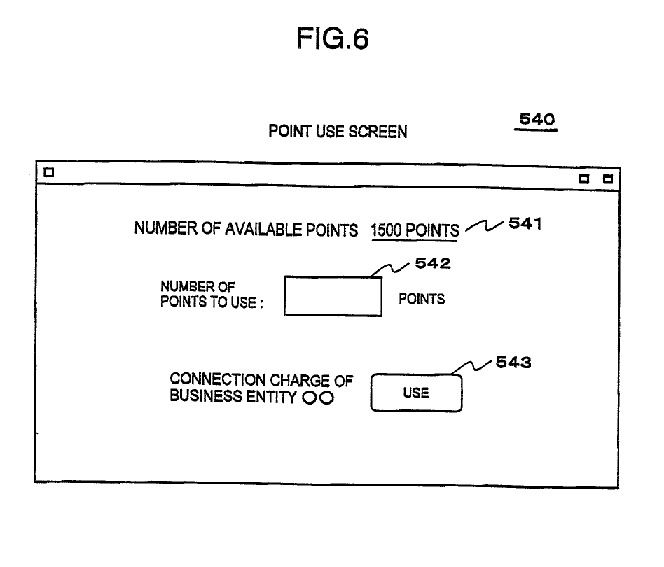

In the online shop set up by the store server 2, the user of the customer terminal 1 can have a point use screen 540, for example as shown in FIG. 6, displayed on the customer terminal 1.

As shown in the figure, the point use screen 540 displays the number of points 541 available to the user of the customer terminal 1, and information on the business entity for which the points can be used, as well as a use button 543.

In this case, the number of points available to the user of the customer terminal 1 is displayed by the store server 2 referring to the number of points obtained by the user of the customer terminal 1 and recorded in the customer database 21. Further, as the information on the business entity, there is displayed the information on the business entity having a point use contract with the store that operates the store server 2. When a plurality of business entities have made such a contract, information on the plurality of business entities is displayed.

In this screen 540, the user of the customer terminal 1 can make a request to the effect that the points obtained from the store server 2 are to be used for payment of the connection charge to the business entity that operates the business entity server 3 (S3). Specifically, out of the number of points obtained by the user of the customer terminal 1, the user can input the number of points to use for payment of the connection charge into a use points input field 542, and can click a use button corresponding to the business entity that operates the business entity server 3.

Upon receipt of the click of the use button 543 from the customer terminal 1, the store server 2 transmits the number of used points and information for identifying the point issuer, i.e., the store that operates the store server 2, to the business entity server 3.

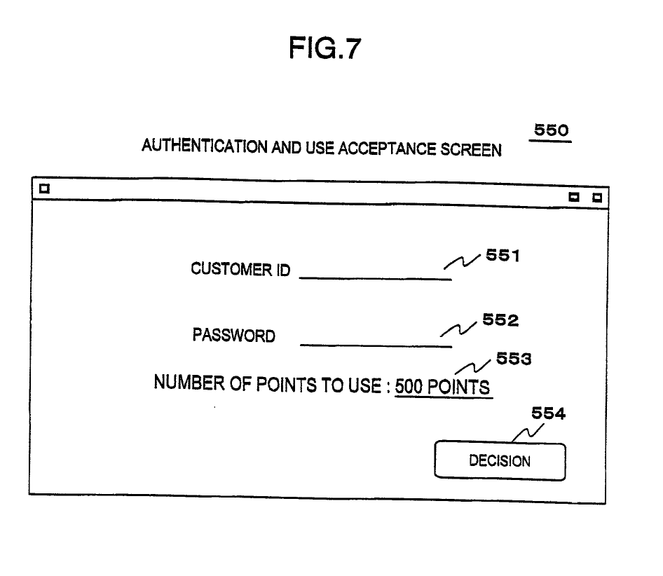

Further, the use button 543 is linked to a Web page set up by the business entity server 3, and the business entity server 3 displays an authentication/use acceptance screen 550, for example as shown in FIG. 7, on the customer terminal 1, to prompt input by the user of the customer terminal 1 (S4). As shown in the figure, the authentication/use acceptance screen 550 has a field 553 for inputting the number of points to use, a field 551 for inputting the customer ID registered in the business entity server 3, a password input field 552, and a decision button 554.

By inputting the same customer ID and password as those registered in the customer database 31 of the business entity server 3, and by clicking the decision button 554, the user of the customer terminal 1 can use the displayed number of points for payment of the connection charge to the business entity that operates the business entity server 3 (S5). A correspondence between the number of used points and the charge has been decided in advance in the contract between the store that operates the store server 2 and the business entity that operates the business entity server 3, for example, as a rate of 1 yen to 1 point, the authentication/use acceptance screen 550 may display the information on the amount of money corresponding to the points to use.

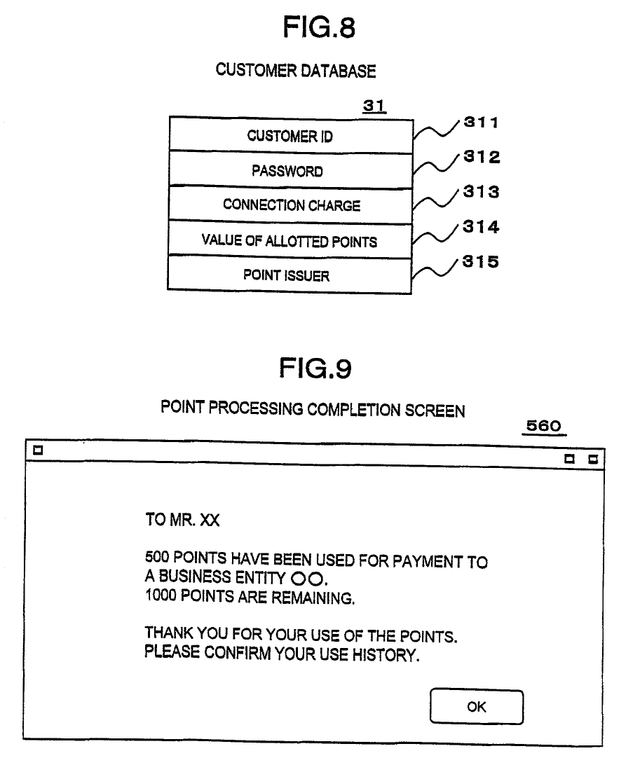

The above customer database 31 managed by the business entity server 3 may have a structure, for example, as shown in FIG. 8. In the figure, the customer database 31 manages a customer ID 311, a password 312, a connection charge 313, a value of allotted points 314, and a point issuer 315 as information for specifying the store that has given the points.

Having received the click of the decision button 554, the business entity server 3 performs authentication processing with the customer ID and password inputted from the customer terminal 1. As a result, when the user of the customer terminal 1 is identified, the amount of money corresponding to the used points is recorded into the field of the value of allotted point 314 of the customer database 31 (S6). Further, the information for specifying the store server 2 is recorded into the field of the point issuer 315 of the customer database 31. Then, a notice of completion of the point use is transmitted to the store server 2 (S7).

Upon receipt of the notice of the completion of the point use, the store server 2 subtracts the number of the used points from the number of points obtained by the user of the customer terminal 1 and recorded in the customer database 21, and records the use of the points for payment to the business entity that operates the business entity server 3 into the purchase history, to update the customer database 21 (S8) Then, the store server 2 displays point processing completion screen 560, for example as shown in FIG. 9, on the customer terminal 1 (S9).

The business entity that operates the business entity server 3 refers to the customer database 31, and bills an amount of the connection charge minus the value of the allotted point to the user of the customer terminal 1, for example, at the time of settlement of each month.

Further, the business entity that operates the business entity server 3 charges the point issuer, i.e., the store that operates the store server 2, for the allotted points' value (S10). When there are a plurality of point issuers, the allotted points' value is separately aggregated for each point issuer, and each aggregate is charged to each point issuer.

At that time, the business entity that operates the business entity server 3 may allow the store that operates the store server 2 to subtract a predetermined amount from the allotted points' value, as an introduction fee charged to the business entity that operates the business entity server 3, for the store bearing the allotted points value to induce the customer. On the contrary, the business entity that operates the business entity server 3 may add a predetermined amount as a handling fee to a charge. The above payment conditions may be decided, as required, when a contract is made between the store that operates the store server 2 and the business entity that operates business entity server 3. Further, the store that operates the store server 2 may pay directly to the business entity that operates the business entity server 3, or may pay through the settlement agency (S11).

The first embodiment of the present invention has been described hereinabove.

A second embodiment of the present invention will be described below with reference to drawings. In the first embodiment, the store that operates the store server 2 and the business entity that operates the business entity server 3 have made the direct contract concerning use of points. In the second embodiment, however, there exists a mediating agency concerning use of points, between the store that operates the store server 2 and the business entity that operates a business entity server 4.

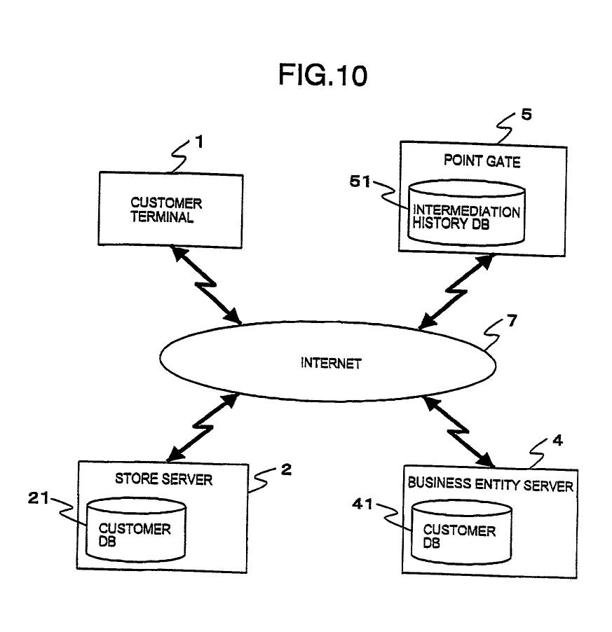

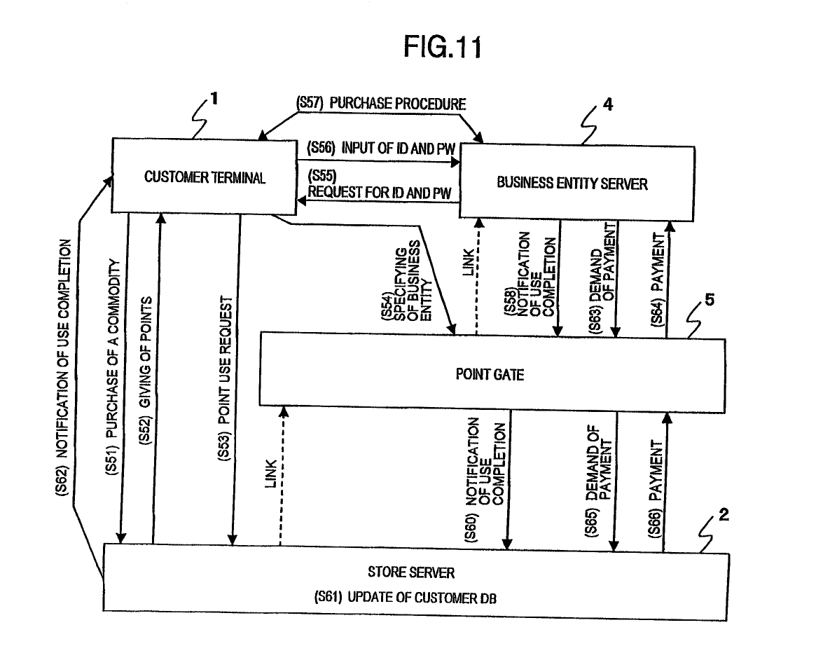

FIG. 10 is a diagram for explaining an outline of a network point settling system of the second embodiment according to the present invention. As shown in the figure, the network point settling system of the present embodiment comprises a customer terminal 1, a store server 2, a business entity server 4, and a point gate 5 as a mediating agency, which are connected with one another through Internet 7.

A user of the customer terminal 1 has already finished registration as a customer of the store server 2, and can use an online shop set up by the store server 2. Namely, a customer database 21 managed by the store server 2 has registered a customer ID and password for specifying the user of the customer terminal 1, an E-mail address a delivery address, credit card information required for settling, a purchase history, and the like.

The store server 2 sets up the online shop on Internet 7. This online shop offers point service, and gives points corresponding, for example, to a purchase amount to a customer who purchases a commodity, service, or the like.

The store server 2 records the points given to the customer into the customer database 21, with relating the points to the customer ID. Points accumulated by the customer can be allotted to part of a purchase price in purchasing a commodity in the online shop, for example, at the conversion rate of 1 yen to 1 point.

The business entity that operates the business entity server 4 is a different organization from the store that operates the store server 2, and offers customer service involving payment of a price on Internet 7. This customer service may take a form, for example, of an online shop different from the store server 2, or may be communication service as an Internet provider or the like.

To receive the customer service offered by the business entity that operates the business entity server 4, registration as a customer of the business entity server 4 is required in advance. The user of the customer terminal 1 has finished registration as a customer of the business entity server. 4, and can use the customer service offered by the business entity that operates the business entity server 4. Namely, the user has registered a customer ID and password for specifying the user of the customer terminal 1, an E-mail address, credit card information required for settling, and the like, into a customer database 41 managed by the business entity server 4. The above customer ID and password registered in the business entity server 4 are not necessarily required to be the same as the customer ID and password registered in the store server 2.

The point gate 5 is a system operated by a settlement mediating agency that mediates use of points and a payment between the store server 2 and the business entity server 4. The point gate may mediate among a plurality of stores and a plurality of business entities. This case will be described later.

The point gate 5 is placed in environment where Internet 7 can be used, like the other servers, and may be implemented by a server computer or the like having a function as a WWW server.

In the present embodiment, the user of the customer terminal 1 can use points given by the store server 2, as a payment for service received (to be received) from the business entity that operates the business entity server 4.

Processing in the second embodiment will be specifically described below. In this embodiment, it is assumed that the business entity that operates the business entity server 4 is also an online ticket distributor. Further, it is assumed that when the user of the customer terminal 1 purchase a desired ticket, the user uses ticket distribution service of a Web page set up by the business entity server 4. When the user of the customer terminal 1 makes an application for purchase of a ticket on this Web page, there arises a liability to pay a ticket price to the business entity that operates the business entity server 4.

The store that operates the store server 2, the business entity that operates the business entity server 4, and the point gate 5 are different organizations from one another, each setting up a different Web site on Internet 7. However, the store that operates the store server 2 and the point gate 5 make a contract to the effect that points given by the store server to a customer can be used in another business entity with which the point gate 5 makes a contract, and a contract to the effect that the store that operates the store server 2 pays an amount of money corresponding to used points to the point gate 5. Further, the point gate 5 and the business entity that operates the business entity server 4 make a contract to the effect that points given to a customer by another business entity with which the point gate 5 makes a contract can be used by the customer for payment to the business entity that operates the business entity server 4, and a contract to the effect that the point gate 5 pays an amount of money corresponding to the used points to the business entity that operates the business entity server 4.

FIG. 11 is a diagram explaining flows of processing in the network point settling system under such conditions.

Processing for the user of the customer terminal 1 to obtain points from the store server 2 is similar to the counterpart in the first embodiment, and its description is omitted (S51), (S52).

The points obtained by the user of the customer terminal 1 can be allotted to part of a purchase price in the commodity purchasing that takes place again or thereafter in the online shop set up by the store server 2, for example, at a conversion rate of 1 yen to 1 point.

Further, in the present embodiment, the above points can be instead allotted to a payment to the business entity that operates the business entity server 4, through the intermediation of the point gate 5. Specifically, the user of the customer terminal 1 can use the points for paying a ticket price to pay to the ticket agency, i.e., the business entity that operates the business entity server 4.

Processing in this case will be described.

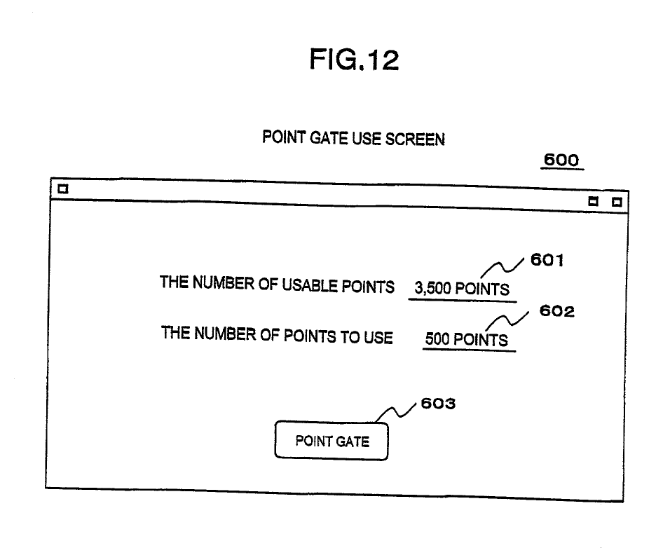

In the online shop set up by the store server 2, the user of the customer terminal 1 can display a point gate use screen 600, for example as shown in FIG. 12, on the customer terminal 1 (S53).

As shown in the figure, the point gate use screen 600 displays the number of points 601 available to the user of the customer terminal 1, and a link button 603 linked to the point gate 5.

The above number of points available to the user of the customer terminal 1 is displayed by the store server 2 referring to the number of points obtained by the user of the customer terminal 1 and recorded in the customer database 21.

In this screen 600, the user of the customer terminal 1 can make a request to the effect that the points obtained from the store server 2 are used for payment to another business entity through the point gate. Specifically, out of the number of points obtained by the user of the customer terminal 1, the user can input the number of points to use for payment to another business entity into a use points number input field 602, and can click the link button 603 linked to the point gate 5.

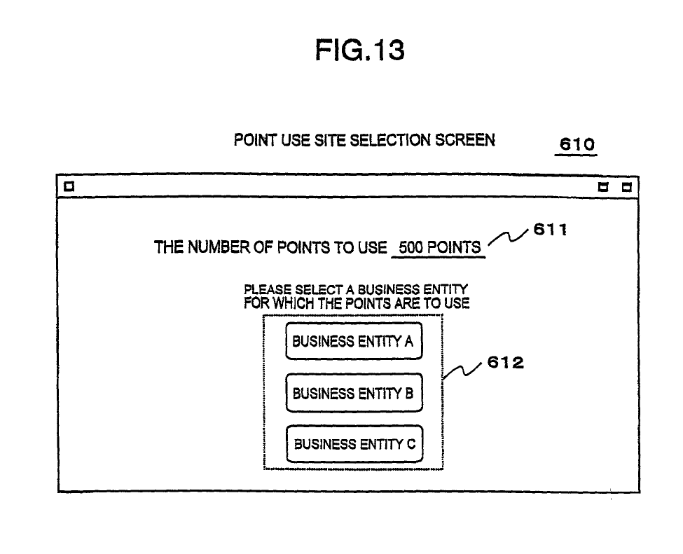

Upon receipt of the click of the link button 603, the point gate 5 displays a point use site selection screen 610, for example as shown in FIG. 13, on the customer terminal 1.

As shown in the figure, this screen 610 displays the number 611 of points to use, and information 612 on a business entity in which those points can be used. As described above, the above “business entity in which those points can be used” is a business entity having the contract with the point gate 5 to the effect that points given to a customer by another business entity having the contract with the point gate 5 can be used for customer's payment to the business entity concerned, and that the point gate 5 pays an amount of money corresponding to the used points to that business entity. When a plurality of such business entities exist, information on a plurality of the business entities is displayed.

A correspondence between the number of used points and a price has been decided in advance in the contract between the store that operates the store server 2 and the point gate 5, for example, as a rate of 1 yen to 1 point. The point use site selection screen 610 may display the information on the amount of money corresponding to the points to use.

The user of the customer terminal 1 can select a desired business entity in the point use site selection screen 610. In this case, it is assumed that the business entity that operates the business entity server 4 (business entity A) is selected or that the corresponding button is clicked (S54).

Upon receipt of the click of the button corresponding to the business entity that operates the business entity server 4, the point gate 5 transmits the number of used points and information on the amount of money corresponding to the used points, to the business entity serves 4.

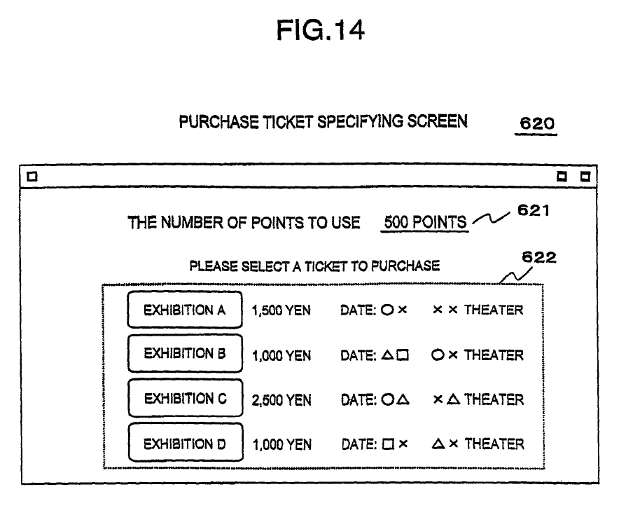

Further, the button corresponding to the business entity that operates the business entity server 4 is linked to the Web page of the business entity server 4, and the business entity server 4 prompts the user of the customer terminal 1 to input the same customer ID and password as those registered in the customer database 41 of the business entity server 4 (S55) to perform authentication processing (S56). When the user of the customer terminal 1 is identified as a result of the authentication processing, the business entity server 4 displays a purchasing ticket specifying screen 620, for example as shown in FIG. 14. In this screen 620, the user of the customer terminal 1 can select a desired ticket.

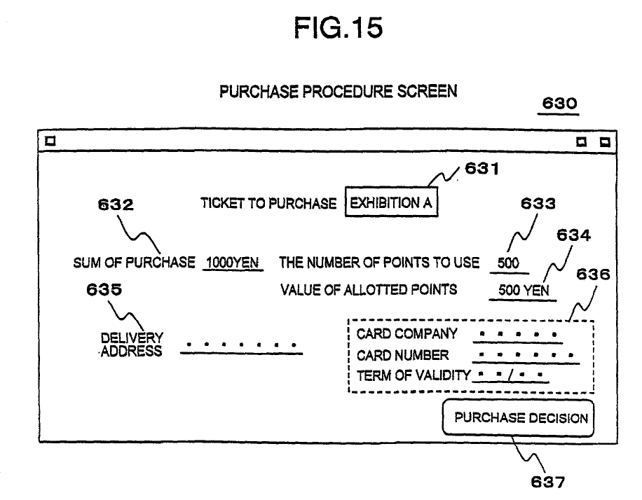

Having received the selection of ticket, the business entity server 4 displays a purchase procedure screen 630, for example as shown in FIG. 15 on the customer terminal 1 (S57). As shown in the figure, this screen 630 includes information required for the purchase procedure, such as the number of points to use 633, an amount of money corresponding to the points to use 634, a ticket pride 632, settling information 636, ticket delivery address 635, and the like, and a purchase decision button 637.

Upon receipt of the click of the purchase decision button 637, the business entity server 4 records these pieces of information into the purchase history in the customer database 41, and at the same time, it starts a delivery procedure for a purchased ticket. Further, the business entity server 4 charges the user of the customer terminal 1 for an amount of the ticket price minus the value of the used points, and transmits a notice of completion of the point use to the point gate 5 (S58).

Having received the notice of the completion of the point use, the point gate 5 records the issuer of the points, i.e., the store that operates the store server 2, the business entity that operates the business entity server 4, the used points, and the amount of money corresponding to the points (value of the allotted points) (S59). Then, the point gate 5 transmits a notice of the completion of the point use to the store server 2 (S60).

Upon receipt of the notice of the completion of the point use, the store server 2 subtracts the number of the used points from the number of points obtained by the user of the customer terminal 1 and recorded in the customer database 21, and records the use of the points for payment through the point gate 5 into the purchase history, to update the customer database 21 (S61). Further, the store server 2 displays a point processing completion screen 560, for example as shown in FIG. 9, on the customer terminal 1 (S62).

The business entity that operates the business entity server 4 bills the amount of money corresponding to the allotted points whose use is received through the point gate 5, to the point gate 5, f or example, at the time of settlement of each month (S63). At that time, the business entity server 4 may subtract a predetermined amount as a handling fee of the point gate 5 from an amount to be charged. For this demand, the point gate 5 makes a payment to the business entity that operates the business entity server 4 (S64).

Further, the point gate 5 charges the value of the allotted points to the point issuer, i.e., the store that operates the store server 2. Namely, the value of the allotted points is separately aggregated for each point issuer, and each aggregate is charged to each point issuer (S65). At that time, the point gate 5 may add a predetermined amount as a handling fee of the point gate in charging to the point issuer. For this demand, the store that operates the store server 2 makes a payment to the point gate 5 (S66).

The above payment conditions may be decided as required when a contract is made between the store that operates the store server 2 and the point gate 5, or between the business entity that operates the business entity server 4 and the point gate 5. The above payments may be made directly or through the mediating agency.

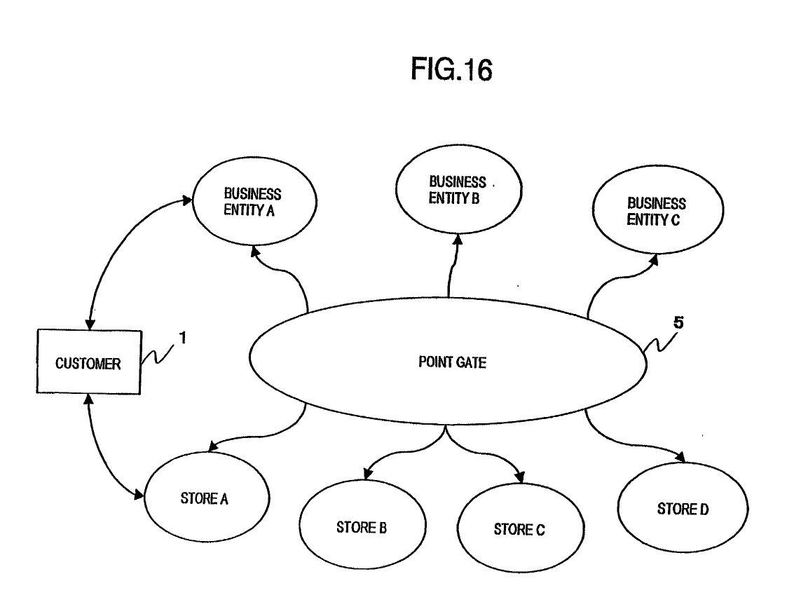

As described above, the point gates may mediate among a plurality of stores and a plurality of business entities, as shown in FIG. 16. In that case, each store may make a settlement using its original points without making a direct contract with each business entity. Further, usually, shops employ a different correspondence between points and an amount of money. For example, a shop A may employ a rate of 1 yen to 1 point, and a shop B may employ a rate of 10 yen to 1 point. In that case, the point gate 5 stores correspondence tables relating each store's point to an amount of money.

The present invention is not limited to the above embodiments, and may be variously modified within the scope of the present invention.

For example, in the second embodiment, the number of points to use is inputted in the Web page 600 of the store server 2 shown in FIG. 12, and thereafter, the ticket to purchase is decided in the Web page 620 of the business entity server 4 shown in FIG. 14. However, there may be employed a constitution in which the number of the points to use out of the points obtained from the store server 2 is decided in the step of deciding the ticket to purchase in the Web page of the business entity server 4.

That case does not perform the processing of transmitting the number of points to use and information for identifying the point issuer, i.e., the store that operates the store server 2 to the point gate 5 when the store server 2 receives the click of the button 603 linked from the customer terminal 1 to the point gate 5 in the point gate use screen 600 shown in FIG. 12. Instead, the store server 2.transmits the number of usable points and information for identifying the point issuer, i.e., the store that operates the store server 2 to the point gate 5.

Then, the point gate 5 transmits the number of usable points to the business entity server 4 so that the number of points to use can be inputted within the number of usable points, in the Web page 600 of the business entity server 4 shown in FIG. 12. By such arrangement, the user of the customer terminal 1 can decide the number of points to use in the step where the ticket to purchase has been decided.

Then, the number of points to use decided by the user of the customer terminal 1 is transmitted to the store server 2 together with the notice of completion of the point use (S60). Upon receipt of the above information, the store server subtracts the number of used points from the number of points obtained by the user of the customer terminal 1 and recorded in the customer database 2, to update the customer database 21.

As described above, the present invention can provide a technique that realizes a new form of point service in which points given as customer service can be used in another store.

What is claimed is:

1. A point management apparatus for storing points that represent economic service to be provided to a customer according to a number of the points, with relating the points to the customer, comprising:
a connection request receiving means for receiving a request for connection with a commodity/service providing apparatus through which the customer should pay money as a price of a commodity or enjoyment of service;
a bearing amount transmitting means for transmitting information on an amount to be borne on the basis of the points related to said customer, to said commodity/service providing apparatus upon receipt of said connection request; and
a payment request receiving means for receiving a payment request based on said amount to be borne, from said commodity/service providing apparatus.

2. A point management apparatus for storing points that represent economic service to a customer according to a number of the points, with relating the points to the customer, comprising:
a connection request receiving means for receiving a request for connection with a commodity/service providing apparatus through which the customer should pay money as a price of a commodity or enjoyment of service;
a point information transmitting means for transmitting information on an upper limit of an amount to be borne on the basis of the points related to said customer, to said commodity/service providing apparatus upon receipt of said connection request;
a bearing amount receiving means for receiving information on the amount to be borne decided by said commodity/service providing apparatus, from said commodity/service providing apparatus; and
a payment request receiving means for receiving a payment request based on said amount to be borne, from said commodity/service providing apparatus.

3. A point management apparatus for storing points that represent economic service to a customer according to a number of the points, with relating the points to the customer, comprising:
a connection request receiving means for receiving a request for connection with a settlement mediating apparatus that mediates settlement using points, from the customer,
a bearing amount transmitting means for transmitting information on an amount to be borne on the basis of the points related to said customer, to said settlement mediating apparatus upon receipt of said connection request; and
a payment request receiving means for receiving a payment request based on said amount to be borne, from said settlement mediating apparatus.

4. A point management apparatus for storing points that represent economic service to a customer according to a number of the points, with relating the points to the customer, comprising:
a connection request receiving means for receiving a request for connection with a settlement mediating apparatus that mediates settlement using points, from the customer;
a point information transmitting means for transmitting information on an upper limit of an amount to be borne based on the points related to said customer, to said settlement mediating apparatus, upon receipt of said connection request;
a bearing amount receiving means for receiving information on the amount to be borne, from said settlement mediating apparatus; and
a payment request receiving means for receiving a payment request based on said amount to be borne, from said settlement mediating apparatus.

5. The point management apparatus according to any one of claims 1-4, wherein:
said points are given to the customer according to a purchase price of the customer concerning an online commodity transaction using a computer network.

6. The point management apparatus according to any one of claims 1-4, wherein:
a said point management apparatus further comprises an online shop means for receiving an order for a commodity transaction through a network; and
said points are given to the customer according to a purchase price of the customer concerning said commodity transaction.

7. The point management apparatus according to any one of claims 1-4, wherein:
said point management apparatus further comprises a means for storing rules specifying a relationship between a number of points and an amount to be borne; and
said amount to be borne on the basis of the points related to said customer is decided within the points related to said customer after receipt of information on points to use from the customer and reference to said rules.

8. The point management apparatus according to any one of claims 1-4, wherein:
said point management apparatus further comprises a point use permit information receiving means, for receiving information implying permission to accept the amount to be borne on the basis of the points, from said commodity/service providing apparatus; and
said point management apparatus outputs information implying completion of using points to said customer upon receipt of said point use permit information.

9. A bearing money guarantee apparatus for guaranteeing bearing of part or all of amount of money to be paid by a customer, to a commodity/service providing apparatus that provides a commodity or service to the customer on condition of payment of a price, comprising:
a means for storing points that represent economic service to the customer according to a number of the points, with relating said points to the customer, wherein,
said guarantee of bearing is based on the number of the points related to the customer.

10. A commodity/service providing apparatus for providing a commodity or service to a customer on condition of payment of a price, comprising:
a borne-amount receiving means for receiving information on an amount to be borne from a bearing guarantee apparatus that guarantees bearing of part or all of amount of money to be paid by said customer;
a price demanding means for demanding payment of an amount of money obtained by subtracting said amount to be borne from the price of said commodity or service, from said customer; and
a bearing amount demanding means for demanding payment of money based on said amount to be borne, from said bearing guarantee apparatus.

11. A commodity/service providing apparatus for providing a commodity or service to a customer on condition of payment of a price, comprising:
a bearing amount upper limit receiving means for receiving information on an upper limit of an amount to be borne from a bearing guarantee apparatus that guarantees bearing of part or all of amount of money to be paid by said customer;
a bearing amount receiving means for outputting said upper limit of the amount to be borne to said customer and receiving information deciding the amount to be borne from the customer;
a price demanding means for demanding payment of an amount of money obtained by subtracting said amount to be borne from the price of said commodity or service, from said customer; and
a bearing amount demanding means for demanding payment of money based on said amount to be borne, from said bearing guarantee apparatus.

12. The commodity/service providing apparatus according to claim 10 or 11, wherein;
said commodity/service providing apparatus is connected with said bearing guarantee apparatus through a computer network; and
said information on the amount to be borne is received through the computer network.

13. The commodity/service providing apparatus according to claim 10 or 11, wherein;
said money based on the amount to be borne is an amount of money obtained by adding an amount of money corresponding to a handling fee to said amount to be borne.

14. The commodity/service providing apparatus according to claim 10 or 11, wherein;
said money based on the amount to be borne is an amount of money obtained by subtracting an amount of money corresponding to an introduction fee from said amount to be borne.

15. A settlement mediating apparatus, comprising:
a borne-amount receiving means for receiving information on an amount to be borne from a bearing guarantee apparatus that guarantees bearing of part or all of amount of money to be paid by a customer;
a connection request receiving means for receiving a request for connection with a commodity/service providing apparatus through which the customer should pay money as a price of a commodity or enjoyment of service;
a borne-amount transmitting means for transmitting information on said amount to be borne, to said commodity/service providing apparatus;
a payment request receiving means for receiving a request of payment of money based on said amount to be borne, from said commodity/service providing apparatus; and
a borne amount demanding means for demanding said payment of the money based on said amount to be borne, from said bearing guarantee apparatus.

16. A settlement mediating apparatus, comprising:
a bearing amount upper limit receiving means for receiving information on an upper limit of an amount to be borne from a bearing guarantee apparatus that guarantees bearing of a part of or all amount of money to be paid by a customer;
a connection request receiving means for receiving a request for a connection with a commodity/service providing apparatus through which the customer should pay money as a price of a commodity or enjoyment of service;
a bearing amount upper limit transmitting means for transmitting information on said upper limit of the amount to be borne, to said commodity/service providing apparatus;
a payment request receiving means for receiving a request of payment of money based on said amount to be borne decided in said commodity/service providing apparatus; and
a borne-amount demanding means that demands said payment of the money based on said amount to be borne, from said bearing guarantee apparatus.

17. The settlement mediating apparatus according to claim 15 or 16, wherein:
said bearing guarantee apparatus, a terminal of said customer, and said commodity/service providing apparatus are connected with said settlement mediating apparatus through a computer network.

18. The settlement mediating apparatus according to claim 17, wherein;
a plurality of bearing guarantee apparatuses and a plurality of commodity/service providing apparatuses are connected with said settlement mediating apparatus.

19. A method of settling points, comprising the steps of;
pre-storing points that represent economic service to a customer according to a number of the points, with relating the points to the customer;
receiving a request for connection with a commodity/service providing apparatus through which the customer should pay money as a price of a commodity or enjoyment of service, and receiving information on an amount to be borne for said price based on the points related to said customer, from the customer;
transmitting said information on the amount to be borne, to said commodity/service providing apparatus; and
performing payment processing upon a payment request based on said amount to be borne from said commodity/service providing apparatus.

20. A method of settling points, comprising the steps of:
pre-storing points that represent economic service to a customer according to a number of the points, with relating the points to the customer;
receiving a request for connection with a commodity/service providing apparatus through which the customer should pay money as a price of a commodity or enjoyment of service, from a customer;
transmitting information on the points related to said customer, to said commodity/service providing apparatus;
receiving information on an amount to be borne based on said points, from said commodity/service providing apparatus; and
performing payment processing upon a payment request based on said amount to be borne from said commodity/service providing apparatus.

21. A method of settling points, comprising the steps of:
pre-storing points that represent economic service to a customer according to a number of the points, with relating the points to the customer;
receiving a request for connection with a settlement mediating apparatus that mediates settlement using the points, and receiving information on an amount to be borne for said price based on said points, from the customer;
transmitting said information on the amount to be borne, to said settlement mediating apparatus; and
performing payment processing upon a payment request based on said amount to be borne from said settlement mediating apparatus.

22. A method of settling points, comprising the steps of:
pre-storing points that represent economic service to a customer according to a number of the points, with relating the points to the customer;
receiving a request for connection with a settlement mediating apparatus from the customer;
transmitting information on the points related to said customer, to said settlement mediating apparatus;
receiving information on an amount to be borne based on said points, from said settlement mediating apparatus; and
performing payment processing upon a payment request based on said amount to be borne from said settlement mediating apparatus.

23. A method of providing a commodity or service to a customer on condition of payment of a price, comprising the steps of:
receiving information on an amount to be borne from a bearing guarantee apparatus that guarantees bearing of part or all of amount of money to be paid by said customer;
requesting said customer for payment of an amount of money obtained by subtracting said amount to be borne from the price of said commodity or service; and
requesting said bearing guarantee apparatus for payment of money based on said amount to be borne.

24. A method of providing a commodity or service to a customer on condition of payment of a price, comprising the steps of:
receiving information on an upper limit of an amount to be borne from a bearing guarantee apparatus that guarantees bearing of part or all of amount of money to be paid by said customer;
outputting said upper limit of the amount to be borne to said customer to prompt said customer's input of information deciding the amount to be borne;
demanding payment of an amount of money obtained by subtracting said amount to be borne from the price for providing said commodity or service, from said customer; and
demanding payment of money based on said amount to be borne, from said bearing guarantee apparatus.

25. A method of mediating settlement, comprising the steps of:
receiving information on an amount to be borne from a bearing guarantee apparatus that guarantees bearing of part or all of amount of money to be paid by a customer, and receiving a request for connection with a commodity/service providing apparatus through which the customer should pay money as a price of said commodity or enjoyment of service;
transmitting said information on the amount to be borne to said commodity/service providing apparatus;
performing payment processing upon a payment request based on said amount to be borne from said commodity/service providing apparatus; and
demanding payment of money based on said amount to be borne, from said bearing guarantee apparatus.

26. A method of mediating settlement, comprising the steps of:
receiving information on an upper limit of an amount to be borne from a bearing guarantee apparatus that guarantees bearing of part or all of amount of money to be paid by a customer, and receiving a request for connection with a commodity/service providing apparatus through which the customer should pay money as a price of said commodity or enjoyment of service;
transmitting said information on the upper limit of the amount to be borne to said commodity/service providing apparatus;
performing payment processing upon a payment request based on the amount to be borne decided by said commodity/service providing apparatus; and
demanding payment of money based on said amount to be borne, from said bearing guarantee apparatus.

27. A network point settling system comprising a point management apparatus and a commodity/service providing apparatus, wherein:
said point management apparatus comprises:
means for storing points that represent economic service to a customer according to a number of the points, with relating the points to the customer:
a connection request receiving means for receiving a request for connection with the commodity/service providing apparatus through which the customer should pay money as a price of a commodity or enjoyment of service;
a bearing amount transmitting means for transmitting information on an amount to be borne on the basis of the points related to said customer, to said commodity/service providing apparatus, and
a payment request receiving means for receiving a payment request based on said allotted amount, from said commodity/service providing apparatus; and
said commodity/service providing apparatus comprises:
means for providing the commodity or service to the customer on condition of payment of a price;
a bearing amount receiving means for receiving information on the amount to be borne from said point management apparatus;
a price demanding means for demanding payment of an amount of money obtained by subtracting said amount to be borne from the price of said commodity or service, from said customer; and
a bearing amount demanding means from demanding payment of money based on said amount to be borne, from said bearing guarantee apparatus.

28. A network point settling system comprising a point management apparatus, a settlement mediating apparatus, and a commodity/service providing apparatus, wherein:
said point management apparatus comprises:
means for storing points that represent economic service to a customer according to a number of the points, relating the points to the customer:
a connection request receiving means for receiving a request for connection with the settlement mediating apparatus that mediates settlement using points, from the customer;
a bearing amount transmitting means for transmitting information on an amount to be borne on the basis of the points related to said customer, to said settlement mediating apparatus; and
a payment request receiving means for receiving a payment request based on said allotted amount, from said settlement mediating apparatus;
said settlement mediating apparatus comprises:
a bearing amount receiving means for receiving information on the amount to be borne from the point management apparatus;
a connection request receiving means for receiving a request for connection with the commodity/service providing apparatus through which the customer should pay money as a price of a commodity or enjoyment of service;
a bearing amount transmitting means for transmitting information on said amount to be borne, to said commodity/service providing apparatus;
a payment request receiving means for receiving a request of payment of money based on said amount to be borne, from said commodity/service providing apparatus; and
a bearing amount demanding means for demanding said payment of the money based on said amount to be borne, from said point management apparatus; and
said commodity/service providing apparatus comprises:
means for providing the commodity or service to the customer on condition of payment of the price;
a bearing amount receiving means for receiving information on the amount to be borne from said settlement mediating apparatus;
a price demanding means for demanding payment of an amount of money obtained by subtracting said amount to be borne from the price of said commodity or service, from said customer; and
a bearing amount demanding means for demanding payment of money based on said amount to be borne, from said settlement mediating apparatus.

29. A program for causing a computer to function as a point management apparatus for storing points that represent economic service to a customer according to a number of the points, with relating the points to the customer, said program realizing the following means in the computer:
a connection request receiving means for receiving a request for connection with a commodity/service providing apparatus through which the customer should pay money as a price of a commodity or enjoyment of service;
a bearing amount transmitting means for transmitting information on an amount to be borne on the basis of the points related to said customer, to said commodity/service providing apparatus upon receipt of said connection request; and
a payment request receiving means for receiving a payment request based on said amount to be borne, from said commodity/service providing apparatus.

30. A program for causing a computer to function as a point management apparatus for storing points that represent economic service to a customer according to a number of the points, with relating the points to the customer, said program realizing the following means in the computer:
a connection request receiving means for receiving a request for connection with a commodity/service providing apparatus through which the customer should pay money as a price of a commodity or enjoyment of service;
a point information transmitting means for transmitting information on an upper limit of an amount to be borne on the basis of the points related to said customer, to said commodity/service providing apparatus upon receipt of said connection request;
a bearing amount receiving means for receiving information on the amount to be borne decided by said commodity/service providing apparatus, from said commodity/service providing apparatus; and
a payment request receiving means for receiving a payment request based on said amount to be borne, from said commodity/service providing apparatus.

31. A program for causing a computer to function as a point management apparatus for storing points that represent economic service to a customer according to a number of the points, with relating the points to the customer, said program realizing the following means in the computer:
a connection request receiving means for receiving a request for connection with a settlement mediating apparatus that mediates settlement using points, from the customer;
a bearing amount transmitting means for transmitting information on an amount to be borne on the basis of the points related to said customer, to said settlement mediating apparatus upon receipt of said connection request; and
a payment request receiving means for receiving a payment request based on said amount to be borne, from said settlement mediating apparatus.

32. A program for causing a computer to function as a point management apparatus for storing points that represent economic service to a customer according to a number of the points, with relating the points to the customer, said program realizing the following means in the computer, namely:
a connection request receiving means for receiving a request for connection with a settlement mediating apparatus that mediates settlement using points, from the customer;
a point information transmitting means for transmitting information on an upper limit of an amount to be borne based on the points related to said customer, to said settlement mediating apparatus upon receipt of said connection request;
a bearing amount receiving means for receiving information on the amount to be borne, from said settlement mediating apparatus; and
a payment request receiving means for receiving a payment request based on said amount to be borne, from said settlement mediating apparatus.

33. A program for causing a computer to function as a commodity/service providing apparatus that provides a commodity or service to a customer on condition of payment of a price, said program realizing the following means in the computer:
a bearing amount receiving means for receiving information on an amount to be borne from a bearing guarantee apparatus that guarantees bearing of part or all of amount of money to be paid by said customer;
a price demanding means for demanding payment of an amount of money obtained by subtracting said amount to be borne from the price of said commodity or service, from said customer; and
a bearing amount demanding means for demanding payment of money based on said amount to be borne, from said bearing guarantee apparatus.

34. A program for causing a computer to function as a commodity/service providing apparatus that provides a commodity or service to a customer on condition of payment of a price, said program realizing the following means in the computer:
a bearing amount upper limit receiving means for receiving information on an upper limit of an amount to be borne from a bearing guarantee apparatus that guarantees bearing of part or all of amount of money to be paid by said customer;
a bearing amount receiving means for outputting said upper limit of the amount to be borne to said customer, and receiving information deciding the amount to be borne from the customer;
a price demanding means for demanding payment of an amount of money obtained by subtracting said amount to be borne from the price of said commodity or service, from said customer; and
a bearing amount demanding means for demanding payment of money based on said amount to be borne, from said bearing guarantee apparatus.

35. A program for causing a computer to function as a settling mediating apparatus, said program realizing the following means in the computer:
a bearing amount receiving means for receiving information on an amount to be borne from a bearing guarantee apparatus that guarantees bearing of part or all of amount of money to be paid by a customer;
a connection request receiving means for receiving a request for connection with a commodity/service providing apparatus through which the customer should pay money as a price of a commodity or enjoyment of service;
a bearing amount transmitting means for transmitting information on said amount to be borne, to said commodity/service providing apparatus;
a payment request receiving means for receiving a request of payment of money based on said amount to be borne, from said commodity/service providing apparatus; and
a bearing amount demanding means for demanding said payment of the money based on said amount to be borne, from said bearing guarantee apparatus.

36. A program for causing a computer to function as a settling mediating apparatus, said program realizing the following means in the computer:
a bearing amount upper limit receiving means for receiving information on an upper limit of an amount to be borne from a bearing guarantee apparatus that guarantees bearing of part or all of amount of money to be paid by a customer;
a connection request receiving means for receiving a request for connection with a commodity/service providing apparatus through which the customer should pay money as a price of a commodity or enjoyment of service;
a bearing amount upper limit transmitting means for transmitting information on said upper limit of the mount to be borne, to said commodity/service providing apparatus;
a payment request receiving means for receiving a request of payment of money based on said amount to be borne decided in said commodity/service providing apparatus; and
a bearing amount demanding means for demanding said payment of the money based on said amount to be borne, from said bearing guarantee apparatus.

37. A computer-readable storing medium having stored a program according to any one of claims 29-36.
